(19) United States
(12) Patent Application Publication
(10) Pub. No.: US 2020/0012834 A1
(43) Pub. Date: Jan. 9, 2020

(54) OPTICAL FINGERPRINT SENSING MODULE

(71) Applicant: Egis Technology Inc., Taipei (TW)

(72) Inventors: Chen-Chih FAN, Taipei (TW); Tong-Long FU, Taipei (TW)

(21) Appl. No.: 16/504,142

(22) Filed: Jul. 5, 2019

Related U.S. Application Data
(60) Provisional application No. 62/694,461, filed on Jul. 6, 2018.

(30) Foreign Application Priority Data
Nov. 16, 2018 (TW) 107140832

(51) Int. Cl. G06K 9/00; G02B 27/00; G02B 1/11; G02B 1/04

(52) U.S. Cl. CPC G06K 9/0004; G06K 9/00087; G02B 1/04; G02B 1/11; G02B 27/0031

(57) ABSTRACT

An optical fingerprint sensing module is provided, including a circuit board, a first light-reflective element, a lens, and an image sensor electrically connected to the circuit board. The optical fingerprint sensing module is disposed below a display panel module. Light is generated by the display panel module and reflected by a finger to propagate along a first direction. Subsequently, light is reflected by the first light-reflective element and propagates through the lens in a second direction to reach the image sensor.

### CROSS REFERENCE TO RELATED APPLICATIONS

This application claims the benefit of U.S. Provisional Application No. 62/694,461, filed on Jul. 6, 2018, and claims priority of Taiwan Patent Application No. 107140832, filed on Nov. 16, 2018, the entirety of which are incorporated by reference herein.

### BACKGROUND OF THE INVENTION

### Field of the Invention

The application relates in general to a fingerprint sensing module, and in particular, to an under-display fingerprint image sensing module.

### Description of the Related Art

Biological identification technology has become increasingly mature, and different biological features can be used to identify individual users. Since the recognition rate and accuracy of fingerprint identification technology are better than those of other biological-feature identification technologies, fingerprint identification and verification are used extensively in various areas.

Fingerprint identification and verification technology detects a user's fingerprint pattern, captures fingerprint data from the fingerprint pattern, and saves the fingerprint data to the memory as a template, or directly saves the fingerprint pattern. Thereafter, the user presses or swipes a finger on or over the fingerprint sensor so that a fingerprint pattern is sensed and fingerprint data is captured, which can then be compared against the template or the stored fingerprint pattern. If the two match, then the user's identity is confirmed.

In recent years, under-display type fingerprint sensors have become more and more common. However, with growing demand for thinner products, the space below the screen (the thickness along the Z axis) becomes very small. As a result, it is hard to design and determine appropriate image distance q and object distance p of the optical system inside the under-display type fingerprint image sensing devices, and the quality of the sensed image would be more or less sacrificed to meet the configuration requirements of the under-display type fingerprint sensors.

Referring to FIG. 1, a traditional under-display type fingerprint image sensing device primarily comprises a display panel module 10, a circuit module 20, an image sensor 30, an optical film 40, a frame 50, and a lens 60 disposed in the frame 50. The circuit module 20 includes a bottom plate 21 and a circuit board 22, and the image sensor 30 is disposed on the circuit board 22.

The display panel module 10 includes a display element 11 and a light permeable element 12 disposed above the display element 11. The display element 11 can emit light to pass through the light permeable element 12 to reach the finger, and light is then reflected by the finger to propagate through the lens 60 and the optical film 40 to reach the image sensor 30. However, as shown in FIG. 1, owing to the considerable thickness of the frame 50 along the Z direction, to reduce the dimensions of the products is difficult. Moreover, the quality of the sensed image may be sacrificed in order to achieve miniaturization of the products.

### BRIEF SUMMARY OF INVENTION

In view of the aforementioned problems, an object of the invention is to provide an optical fingerprint sensing module for sensing a fingerprint pattern of a finger. The optical fingerprint sensing module includes a circuit board, an image sensor, a first light-reflective element, and a lens. The circuit board is disposed below a display panel module. The image sensor is electrically connected to the circuit board. The first light-reflective element is disposed between the display panel module and the circuit board. The lens is disposed between the display panel module and the circuit board, wherein the light generated by the display panel module is reflected by the finger to propagate along a first direction, and the light is then reflected by the first light-reflective element to propagate through the lens along a second direction and reach the image sensor.

In some embodiments, the image sensor has a sensing surface perpendicular to the upper surface and an optical axis of the lens, and light is reflected by the first light-reflective element to propagate through the lens along the second direction and then reach the image sensor.

In some embodiments, the circuit board has a protrusion, and the image sensor is affixed to the protrusion and electrically connected to the circuit board.

In some embodiments, the lens is movable relative to the first light-reflective element in a horizontal direction parallel to the optical axis of the lens.

In some embodiments, the optical fingerprint sensing module further includes a Voice Coil Motor (VCM) or piezoelectric micro actuator driving the lens to move relative to the first light-reflective element in the horizontal direction.

In some embodiments, the first light-reflective element is movable relative to the lens in a horizontal direction to adjust a distance between the first light-reflective element and the lens, and the horizontal direction is parallel to the optical axis of the lens.

In some embodiments, the first light-reflective element is rotatable around a rotary axis perpendicular to the optical axis of the lens.

In some embodiments, the first light-reflective element has a reflecting surface, and the reflecting surface and the optical axis form an included angle of from 35 degrees to 55 degrees.

In some embodiments, the optical fingerprint sensing module further includes an optical element having a polarizer, IR cut-off filter, or anti-reflective coating layer, wherein light propagates through the optical element in the first direction to reach the first light-reflective element.

In some embodiments, the optical fingerprint sensing module further includes a frame supporting the lens, wherein the frame comprises anti-infrared material.

In some embodiments, the display element comprises an OLED or TFT-LCD display element.

In some embodiments, the optical fingerprint sensing module further includes a second light-reflective element, and the image sensor has a sensing surface parallel to the upper surface and an optical axis of the lens, wherein light is reflected by the first light-reflective element to propagate through the lens along the second direction and then reflected by the second light-reflective element to propagate along a third direction to reach the sensing surface of the image sensor.

In some embodiments, the first light-reflective element is movable relative to the lens in a horizontal direction parallel to the optical axis of the lens.

In some embodiments, the second light-reflective element is rotatable around a rotary axis perpendicular to the optical axis of the lens.

In some embodiments, the second light-reflective element has a reflecting surface, and the reflecting surface and the optical axis form an included angle of from 35 degrees to 55 degrees.

In some embodiments, the lens is movable relative to the first light-reflective element or the second light-reflective element in a horizontal direction parallel to the optical axis of the lens.

In some embodiments, the optical fingerprint sensing module further includes a Voice Coil Motor (VCM) or piezoelectric micro actuator driving the lens to move relative to the first light-reflective element or the second light-reflective element in the horizontal direction.

### BRIEF DESCRIPTION OF DRAWINGS

The invention can be more fully understood by reading the subsequent detailed description and examples with references made to the accompanying drawings, wherein:

FIG. 1 is a schematic diagram of a traditional under-display type fingerprint image sensing device.

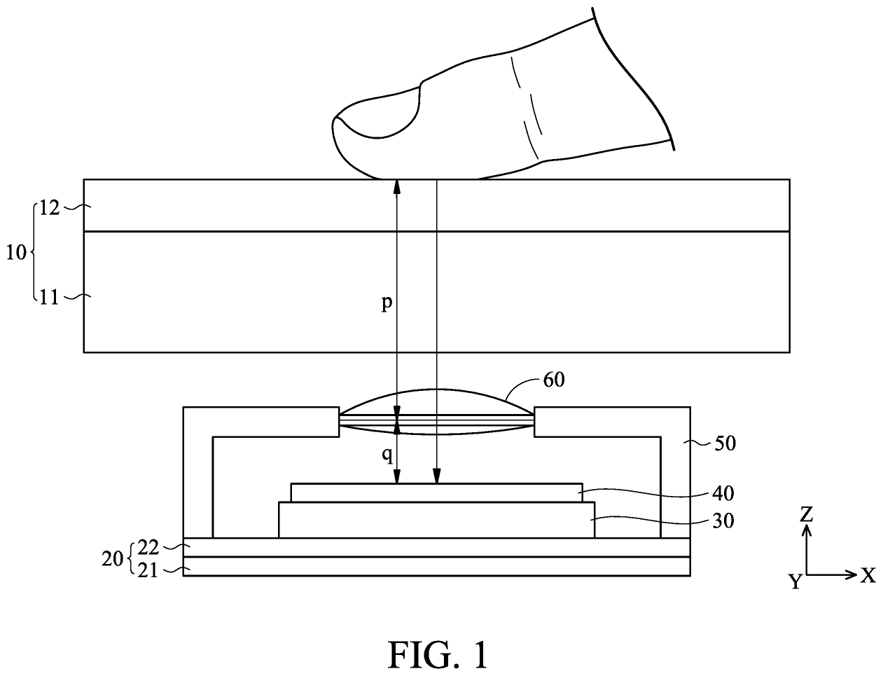

FIG. 2 is a schematic diagram of an optical fingerprint sensing device in accordance with an embodiment of the invention.

FIG. 3 is a schematic diagram of an optical fingerprint sensing device in accordance with another embodiment of the invention.

FIG. 4 is a schematic diagram of an optical fingerprint sensing device in accordance with another embodiment of the invention.

FIG. 5 is a schematic diagram of an optical fingerprint sensing device in accordance with another embodiment of the invention.

FIG. 6 is a schematic diagram of an optical fingerprint sensing device in accordance with another embodiment of the invention.

FIG. 7 is a schematic diagram of an optical fingerprint sensing device in accordance with another embodiment of the invention.

### DETAILED DESCRIPTION OF INVENTION

The making and using of the embodiments of an optical fingerprint sensing module are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

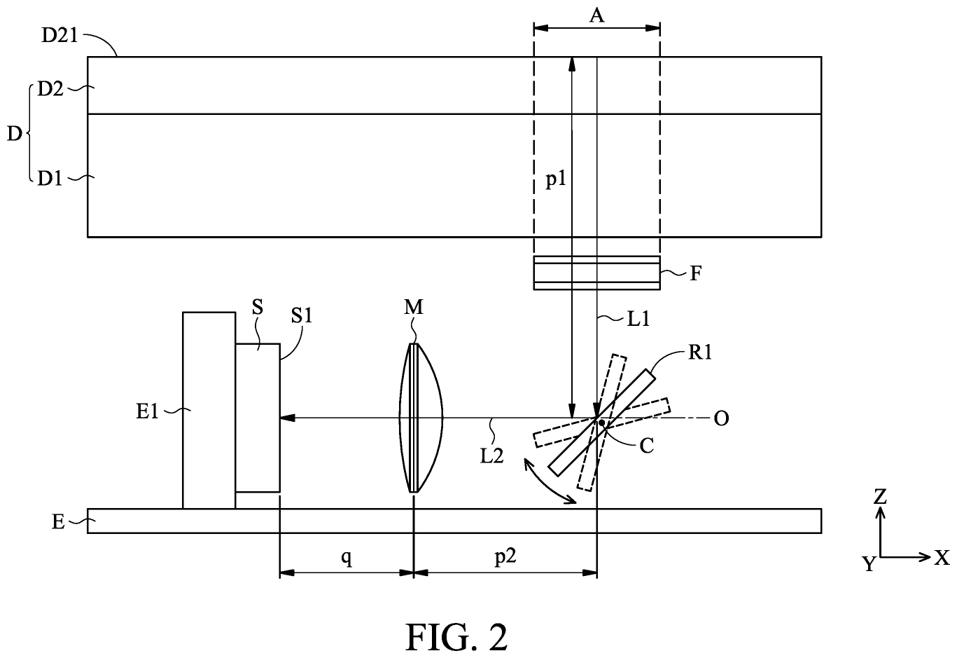

FIG. 2 is a schematic diagram of an optical fingerprint sensing device in accordance with an embodiment of the invention. As shown in FIG. 2, the optical fingerprint sensing device in this embodiment can be used to sense a fingerprint pattern of a finger. The optical fingerprint sensing device primarily comprises a display panel module D, a circuit board E, an optical element F, a first light-reflective element R1, a lens M, and an image sensor S. Here, the circuit board E, the optical element F, the first light-reflective element R1, the lens M and the image sensor S constitute an under-display type optical fingerprint sensing module disposed below the display panel module D.

In this embodiment, the display panel module D includes a display element D1 and a light permeable element D2 disposed on the display element D1. The light permeable element D2 may be a sheet glass, and the display element D1 may comprise Organic Light-Emitting Diodes (OLEDs), TFT-LCDs or touch display components. It should be noted that the display element D1 may include a plurality of light emitting units as light sources, thereby emitting light to pass through the light permeable element D2 to reach the finger thereon.

Still referring to FIG. 2, when using the optical fingerprint sensing device to capture a fingerprint pattern, the finger of a user has to be placed within a sensing area A on an upper surface D21 of the light permeable element D2. Subsequently, light emitted from the light sources in the display element D1 penetrates through the light permeable element D2 to reach the finger in the sensing area A, and the light is reflected by the finger and then passes through the light permeable element D2, the display element D1 and the optical element F along a first direction (−Z direction), as the arrow L1 indicates in FIG. 2. Then, the light is reflected by the first light-reflective element R1 to propagate through the lens M along a second direction (-X direction) and reach the image sensor S, as the arrow L2 indicates in FIG. 2.

In some embodiments, the optical element F may comprise a polarizer, IR cut-off filter, or anti-reflective coating layer to block stray light and increase signal-to-noise ratio (SNR), thereby improving the accuracy of fingerprint identification.

When the image sensor S receives light L2 that passes through the lens M, it converts light signals into electrical signals. Subsequently, the circuit board E transfers the electrical signals to a processor (not shown), wherein the electrical signals include the fingerprint pattern information. Thereafter, data storage of and biological identification on the fingerprint pattern can be performed.

Specifically, the circuit board E in FIG. 2 has a protrusion E1 extending toward the display panel module D. The image sensor S is mounted on the protrusion E1 and electrically connected to the circuit board E. In some embodiments, the image sensor S may comprise Charge Coupled Device (CCD) or CMOS Image Sensor (CIS), and a sensing surface S1 of the image sensor S is substantially perpendicular to the upper surface D21 of the light permeable element D2 and the optical axis O of the lens M, wherein the upper surface D21 and the optical axis O are parallel to the X axis as shown in FIG. 2.

The lens M in this embodiment may have the function of auto focusing, and it can be driven by voice coil motor (VCM) or piezoelectric micro actuator to move relative to the image sensor S along a horizontal direction parallel to the X axis, so that the distance between the lens M and the image sensor S can be appropriately adjusted for rapid focusing. Additionally, the first light-reflective element R1 may also be driven by voice coil motor (VCM) or piezoelectric micro actuator to rotate around a rotary axis C. Thus, the propagation direction of light can be appropriately adjusted to increase the dimensions of the sensing area A, wherein the rotary axis C is perpendicular to the optical axis O of the lens M.

For example, when the first light-reflective element R1 is located at a predetermined position, the reflecting surface of the first light-reflective element R1 and the optical axis O of the lens M form an included angle about 45 degrees. Here, the first light-reflective element R1 can rotate around the rotary axis C, so that the included angle between the reflecting surface of the first light-reflective element R1 and the optical axis O of the lens M can be appropriately adjusted from 10 degrees to 80 degrees, preferably from 35 degrees to 55 degrees.

As mentioned above, the first light-reflective element R1 can reflect the light (bounced from the finger) to propagate through the lens M along a horizontal direction and reach the image sensor S. Therefore, the image distance q and the object distance (which is equal to the sum of the distances p1 and p2 in FIG. 2) can be increased, and the thickness of the optical fingerprint sensing device along the Z direction can be efficiently reduced to facilitate miniaturization of end products.

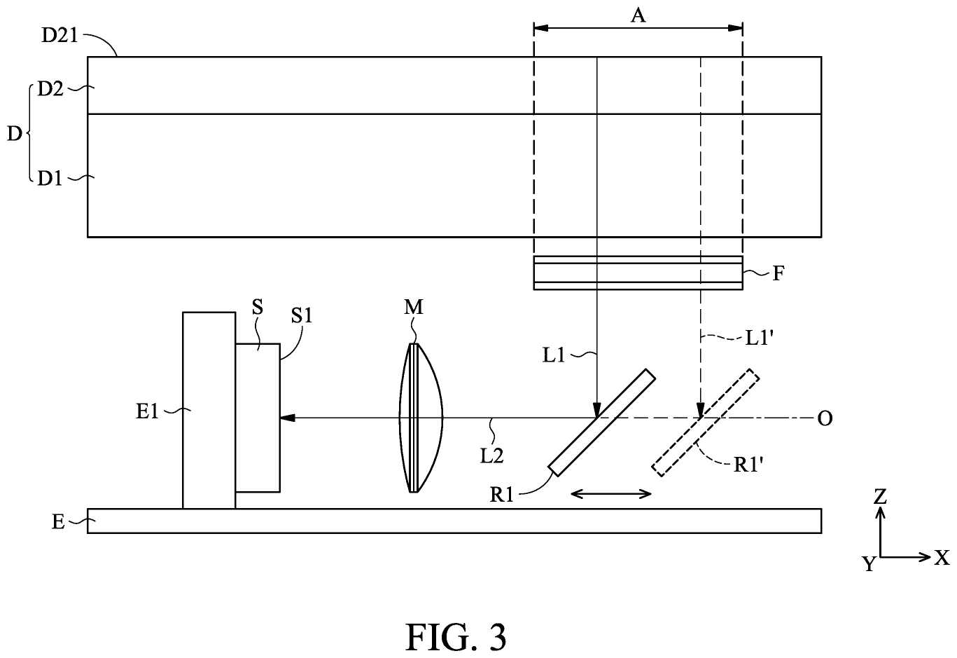

FIG. 3 is a schematic diagram of an optical fingerprint sensing device in accordance with another embodiment of the invention. Different from FIG. 2, the first light-reflective element R1 of FIG. 3 can further be driven by voice coil motor (VCM) or piezoelectric micro actuator to move relative to the lens M in the horizontal direction, so that the distance between the first light-reflective element R1 and the lens M can be adjusted to define a larger sensing area A.

As shown in FIG. 3, when the first light-reflective element R1 moves along the horizontal direction (X axis) to the position R1′, the first light-reflective element R1 can receive and reflect light L1′ from different positions of the sensing area A. Therefore, a larger area of the finger may be scanned and fingerprint sensed. That is, the area of the fingerprint sensing area A can be enlarged. This results in the accuracy of fingerprint identification can be improved.

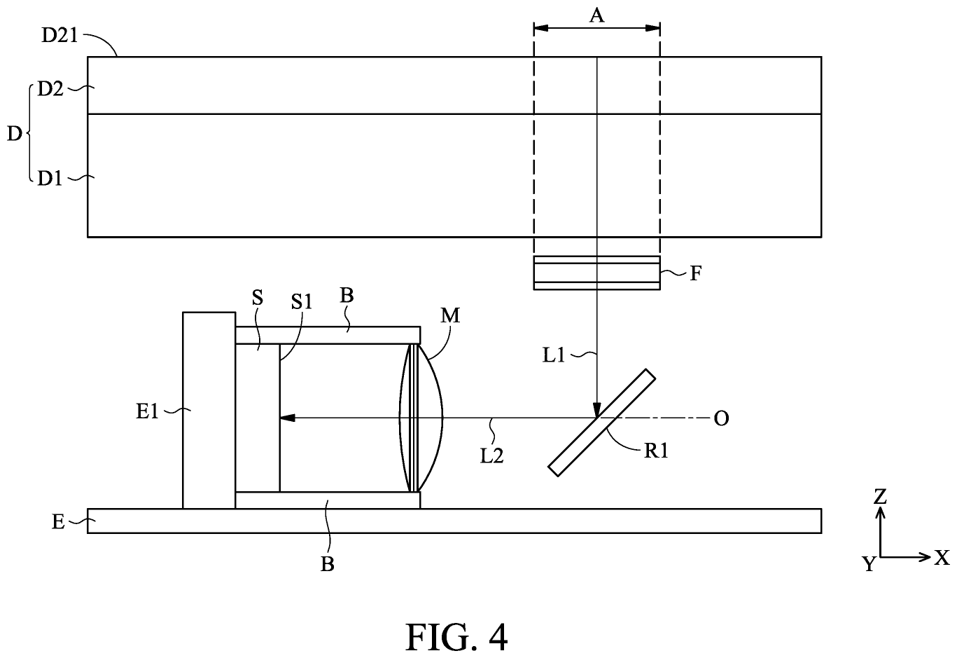

FIG. 4 is a schematic diagram of an optical fingerprint sensing device in accordance with another embodiment of the invention. Different from FIG. 2, the optical fingerprint sensing device of FIG. 4 further comprises a frame B supporting the lens M. In some embodiments, the frame B may be made of anti-infrared material or comprise an anti-infrared layer such as IR cut-off filter coating to block infrared light from entering the image sensor S. Therefore, undesired light noise can be prevented to ensure the quality of the fingerprint image captured by the image sensor S.

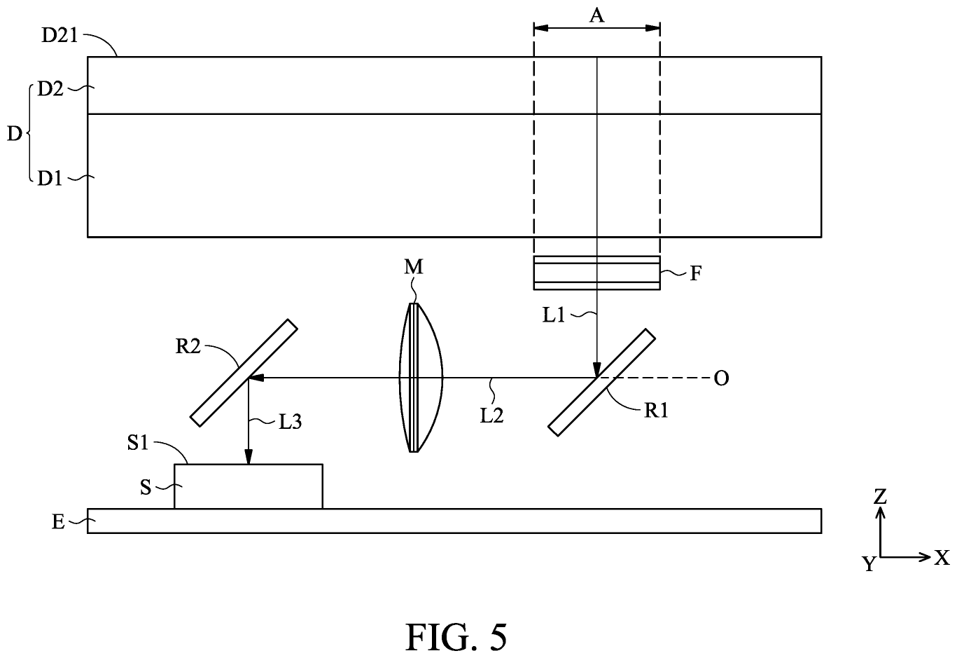

FIG. 5 is a schematic diagram of an optical fingerprint sensing device in accordance with another embodiment of the invention. Different from FIG. 2, the optical fingerprint sensing device of FIG. 5 further comprises a second light-reflective element R2, and the image sensor S is laid down on the circuit board E. In this embodiment, the sensing surface S1 of the image sensor S is substantially parallel to the upper surface D21 of the light permeable element D2 and the optical axis O of the lens M.

As shown in FIG. 5, light is reflected by the first light-reflective element R1 and propagates through the lens M to reach the second light-reflective element R2. Subsequently, light is reflected by the second light-reflective element R2 and propagates in a third direction (−Z direction) to reach the image sensor S, as the arrow L3 indicates in FIG. 5. In some embodiments, the lens M may have the function of auto focusing, and it can be driven by voice coil motor (VCM) or piezoelectric micro actuator to move relative to the first light-reflective element R1 and/or the second light-reflective element R2 in the horizontal direction parallel to the X axis. Therefore, the distance between the lens M and the second light-reflective element R2 can be appropriately adjusted to facilitate rapid focusing of the optical fingerprint sensing device.

With the configuration of FIG. 5, the protrusion E1 (FIGS. 2-4) can be removed from the circuit board E, and the dimension of the optical fingerprint sensing device in the horizontal direction can be efficiently reduced. In this embodiment, light is guided to be reflected by the first and second light-reflective elements R1 and R2 (i.e. reflected twice) and then to reach the image sensor S. Therefore, both the image and object distances of the optical system can be increased, and the thickness of the optical fingerprint sensing device along the vertical direction (Z axis) can be efficiently reduced to facilitate miniaturization of the end product.

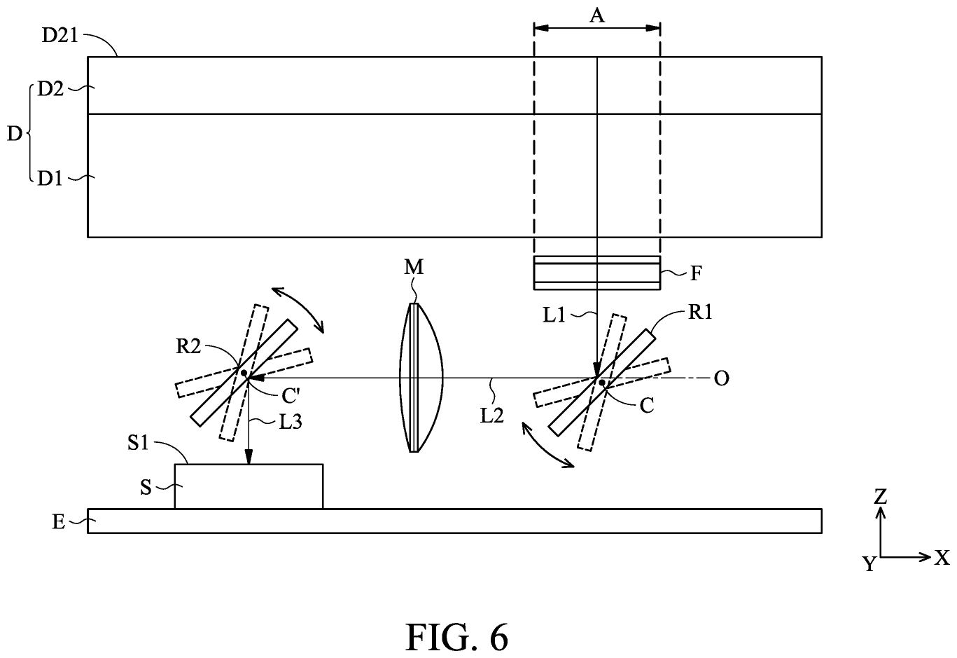

FIG. 6 is a schematic diagram of an optical fingerprint sensing device in accordance with another embodiment of the invention. Different from FIG. 5, the first light-reflective element R1 of FIG. 6 can be driven by voice coil motor (VCM) or piezoelectric micro actuator to rotate around a rotary axis C that is perpendicular to the optical axis O of the lens M. Thus, the propagation direction of the reflected light can be appropriately adjusted to enlarge the sensing area A. Similarly, the second light-reflective element R2 can also be driven by voice coil motor (VCM) or piezoelectric micro actuator to rotate around another rotary axis C′ that is perpendicular to the optical axis O of the lens M, so as to adjust the propagation direction of the reflected light and improve the image quality of the image sensor S.

For example, when the first light-reflective element R1 is located at a predetermined position, the reflecting surface of the first light-reflective element R1 and the optical axis O of the lens M form an included angle about 45 degrees. Here, the first light-reflective element R1 can rotate around the rotary axis C, so that the included angle between the reflecting surface of the first light-reflective element R1 and the optical axis O of the lens M can be appropriately adjusted to form an included angle from 10 degrees to 80 degrees, preferably from 35 degrees to 55 degrees.

Similarly, when the second light-reflective element R2 is located at a predetermined position, the reflecting surface of the second light-reflective element R2 and the optical axis O of the lens M form an included angle about 45 degrees. In this embodiment, the second light-reflective element R2 is rotatable around the rotary axis C′, so that the included angle between the reflecting surface of the second light-reflective element R2 and the optical axis O of the lens M can be appropriately adjusted from 10 degrees to 80 degrees, preferably from 35 degrees to 55 degrees.

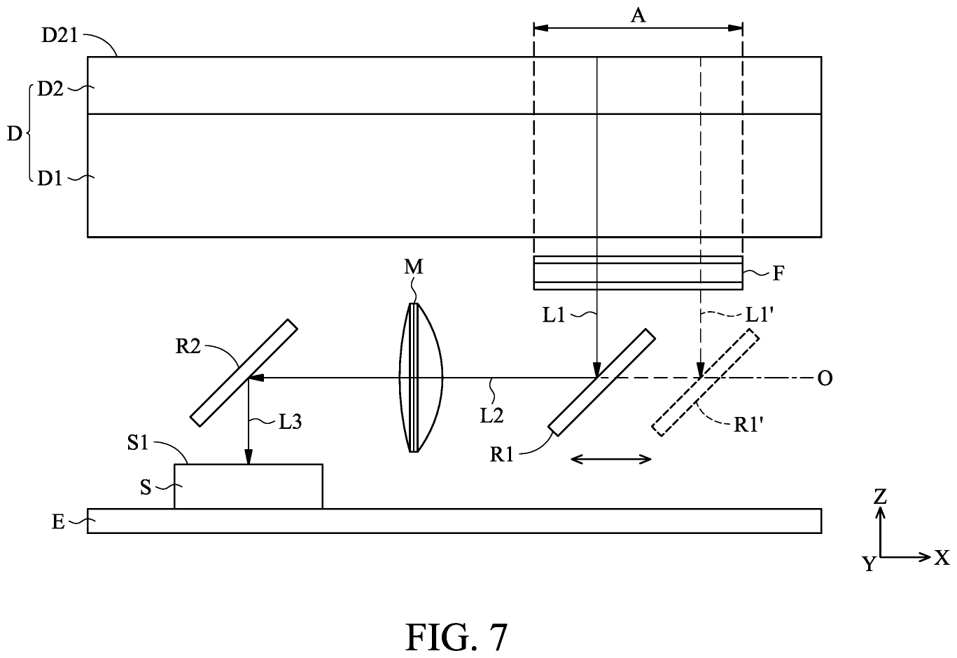

FIG. 7 is a schematic diagram of an optical fingerprint sensing device in accordance with another embodiment of the invention. Different from FIG. 5, the first light-reflective element R1 of FIG. 7 can be driven by voice coil motor (VCM) or piezoelectric micro actuator to move relative to the lens M in the horizontal direction, so that the distance between the first light-reflective element R1 and the lens M can be appropriately adjusted, and the dimensions of the sensing area A can therefore be increased to enlarge the area of the scanned fingerprint.

As shown in FIG. 7, when the first light-reflective element R1 moves in the horizontal direction (X axis) to the position R1′, the first light-reflective element R1 can reflect light L1′ from different positions of the sensing area A. Therefore, the dimensions of the sensing area A can be enlarged, and a larger area of the fingerprint of the finger may be sensed, so as to improve the accuracy of fingerprint identification.

In summary, the invention provides an optical fingerprint sensing device that includes at least one light-reflective element and a lens disposed on an optical path between the display panel module and the image sensor, so that the propagation direction of light can be appropriately adjusted, and the image and object distances can be increased. Therefore, the image quality can be improved, and the thickness of the optical fingerprint sensing device along the vertical direction (Z direction) can be efficiently reduced for miniaturization of end products.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical fingerprint sensing module for sensing a fingerprint pattern of a finger placed on an upper surface of a display panel module, wherein light is generated by the display panel module and then reflected by the finger, the optical fingerprint sensing module comprising:
a circuit board, disposed below the display panel module;
an image sensor, electrically connected to the circuit board;
a first light-reflective element, disposed between the display panel module and the circuit board; and
a lens, disposed between the display panel module and the circuit board, wherein light generated by the display panel module is reflected by the finger to propagate along a first direction, and the light is then reflected by the first light-reflective element to propagate through the lens along a second direction and then reach the image sensor.

2. The optical fingerprint sensing module as claimed in claim 1, wherein the image sensor has a sensing surface perpendicular to the upper surface and an optical axis of the lens, and the light is reflected by the first light-reflective element to propagate through the lens along the second direction and then reach the image sensor.

3. The optical fingerprint sensing module as claimed in claim 2, wherein the circuit board has a protrusion, and the image sensor is affixed to the protrusion and electrically connected to the circuit board.

4. The optical fingerprint sensing module as claimed in claim 3, wherein the lens is movable relative to the first light-reflective element in a horizontal direction parallel to the optical axis of the lens.

5. The optical fingerprint sensing module as claimed in claim 4, further comprising a Voice Coil Motor (VCM) or piezoelectric micro actuator driving the lens to move relative to the first light-reflective element in the horizontal direction.

6. The optical fingerprint sensing module as claimed in claim 2, wherein the first light-reflective element is movable relative to the lens in a horizontal direction to adjust a distance between the first light-reflective element and the lens, and the horizontal direction is parallel to the optical axis of the lens.

7. The optical fingerprint sensing module as claimed in claim 2, wherein the first light-reflective element is rotatable around a rotary axis perpendicular to the optical axis of the lens.

8. The optical fingerprint sensing module as claimed in claim 7, wherein the first light-reflective element has a reflecting surface, and the reflecting surface and the optical axis form an included angle of from 35 degrees to 55 degrees.

9. The optical fingerprint sensing module as claimed in claim 2, further comprising an optical element having a polarizer, an IR cut-off filter, or an anti-reflective coating layer, wherein light propagates through the optical element in the first direction to reach the first light-reflective element.

10. The optical fingerprint sensing module as claimed in claim 2, further comprising a frame supporting the lens, wherein the frame comprises anti-infrared material.

11. The optical fingerprint sensing module as claimed in claim 2, wherein the display element comprises an OLED or TFT-LCD display element.

12. The optical fingerprint sensing module as claimed in claim 1, further comprising a second light-reflective element, and the image sensor has a sensing surface parallel to the upper surface and an optical axis of the lens, wherein light is reflected by the first light-reflective element to propagate through the lens along the second direction and then reflected by the second light-reflective element to propagate along a third direction to reach the sensing surface of the image sensor.

13. The optical fingerprint sensing module as claimed in claim 12, wherein the first light-reflective element is movable relative to the lens in a horizontal direction parallel to the optical axis of the lens.

14. The optical fingerprint sensing module as claimed in claim 12, wherein the second light-reflective element is rotatable around a rotary axis perpendicular to the optical axis of the lens.

15. The optical fingerprint sensing module as claimed in claim 14, wherein the second light-reflective element has a reflecting surface, and the reflecting surface and the optical axis form an included angle of from 35 degrees to 55 degrees.

16. The optical fingerprint sensing module as claimed in claim 12, wherein the lens is movable relative to the first light-reflective element or the second light-reflective element in a horizontal direction parallel to the optical axis of the lens.

17. The optical fingerprint sensing module as claimed in claim 16, further comprising a Voice Coil Motor (VCM) or piezoelectric micro actuator driving the lens to move relative to the first light-reflective element or the second light-reflective element in the horizontal direction.
